(19) United States
(12) Patent Application Publication
(10) Pub. No.: US 2026/0023860 A1
(43) Pub. Date: Jan. 22, 2026

(54) SYSTEMS AND METHODS FOR SOFTWARE APPLICATION VULNERABILITY EVALUATION RESOURCE OPTIMIZATION

(71) Applicant: Wells Fargo Bank, N.A., San Francisco, CA (US)

(72) Inventors: Michael Sbandi, Charlotte, NC (US); Ajoy Kumar, New York, NY (US); Jay Joseph Reynolds, Charlotte, NC (US); Bradford A. Shea, Mint Hill, NC (US)

(21) Appl. No.: 18/778,533

(22) Filed: Jul. 19, 2024

(51) Int. Cl. G06F 21/57

(52) U.S. Cl. CPC G06F 21/577; G06F 2221/033

(57) ABSTRACT

Systems, apparatuses, methods, and computer program products are disclosed for providing software application vulnerability evaluation resource (SAVER) optimization. An example method includes receiving a software application and determining a first software application evaluation task for execution with respect to the software application. The example method also includes determining, based on a first set of evaluation task requirements, a first SAVER to execute the first software application evaluation task. The example method also includes providing an indication of the first SAVER to a computing device.

### BACKGROUND

Detecting vulnerabilities in software applications, websites, and/or the like is necessary for the secure deployment and operation of said software applications, websites, and/or the like. However, conventional software application evaluation systems and techniques exhibit numerous drawbacks, inefficiencies, and limitations.

### BRIEF SUMMARY

Software applications and software application frameworks are a ubiquitous and necessary component of modern-day life. For example, many individuals utilize software applications configured to access communications networks (e.g., Internet and phone-based networks) to manage almost every aspect of their life including finance management (e.g., banking, bill payments), education (e.g., accessing educational resources, attending school online), work, and/or the like. Similarly, nearly every enterprise (e.g., financial institutions, businesses, organizations) rely on both private and public software applications in order to manage daily business operations, logistics, and more. It is therefore crucially important that any software application to be used by an individual or enterprise be thoroughly evaluated for security purposes to ensure the software application does not expose the individual or enterprise to the risk of data, financial, and/or privacy loss.

Lack of sufficient evaluation and testing of software applications may lead to the loss of sensitive data such as personal identifiable information (PII) (e.g., social security information, contact information), financial data (e.g., account identification data, account balance data), enterprise data (e.g., trade secrets, client data, employee data), and/or the like at the hands of bad actors. Furthermore, undetected vulnerabilities associated with a software application may be exploited by bad actors in order to attack a software application framework associated with an individual or enterprise for the sake of collecting a ransom, sowing chaos, or otherwise taking advantage of the individual or enterprise. It is therefore desirable to have a software application thoroughly evaluated, tested, and/or otherwise analyzed by a software security professional in order to ensure the software application is free of any vulnerabilities that may be exploited by bad actors for nefarious purposes.

However, historically, enterprises (e.g., financial institutions, banks, corporations, and/or the like) have not had an efficient, effective way to identify various necessary software application evaluation tasks associated with a respective software application and/or an appropriate software security professional to execute various necessary software application evaluation tasks. As such, the conventional means for evaluating and/or testing software applications may result in high costs, wasted technological and/or personnel resources, and/or the loss of sensitive data as a result of poor software application evaluation, testing, and/or software security professional assignment. In contrast to conventional techniques for evaluating and/or testing software applications, example embodiments described herein comprise a machine learning (ML)-based software application vulnerability evaluation resource (SAVER) management system configured to provide SAVER optimization, where a SAVER may be a software penetration tester, software security professional, software developer, white hat hacker, automated software application testing system, and/or the like.

In example embodiments, the SAVER management system may, at least in part, (i) receive a software application (e.g., software application package(s), executable program code files) and/or a reference (e.g., a hyperlink) associated with the software application; (ii) determine a software application evaluation task for execution with respect to the software application, wherein the software application evaluation task is associated with a set of evaluation task requirements; (iii) determine, based on the set of evaluation task requirements, a SAVER to execute the software application evaluation task; and (iv) provide an indication of the SAVER to a computing device associated with an enterprise and/or an individual associated with the software application.

Accordingly, the present disclosure sets forth systems, methods, and apparatuses that provide SAVER optimization. There are many advantages of these, and other embodiments described herein. One advantage the SAVER management system provides, as described herein, is an improvement to the functioning of the computing infrastructure of an enterprise, such as by reducing the burden on computing and personnel resources. For instance, the SAVER management system described herein reduces the complexity of determining one or more software application evaluation tasks by, among other things, automating processes such as determining a set of evaluation task requirements associated with the one or more software application evaluation tasks, determining (e.g., selecting, delegating, assigning) a particular SAVER to execute one or more respective software application evaluation tasks, and providing an indication (e.g., notification, work assignment) of the determination of the SAVER to one or more computing devices.

Due to the specific configuration, platform, technology stack (e.g., collection of software programming languages or frameworks), and/or native computing device associated with a particular software application, a general delegation of various software application evaluation tasks to one or more SAVERS may not be appropriate nor desirable. In this regard, the SAVER management system employs a set of ML models to determine the strengths and weaknesses of a respective SAVER before one or more software application evaluation tasks are delegated or assigned to the respective SAVER. SAVERS with different skillsets may bring unique perspectives and methodologies to an enterprise, and collaborating over diverse specialties may help enterprises conduct thorough software application evaluations and assessments, thereby discovering a broader range of vulnerabilities and implementing more effective strategies to enhance their cybersecurity defenses. As such, the SAVER management system may be configured to optimize the impact of the strengths of one or more SAVERs (e.g., their skillsets, specializations, abilities, domain knowledge) and minimize the weaknesses of the one or more SAVERs (e.g., their knowledge gaps, problem areas, inabilities).

Another advantage of the SAVER management system, as described herein, is an improvement to software application technologies by providing an increased security for sensitive data, information, and/or valuable resources related to users and/or enterprises by leveraging a set of ML models to identify, analyze, and optimally assign SAVERs to various software application evaluation tasks to ensure the respective software applications are sufficiently configured to defend against any adverse exploitation attempts made by bad actors. For example, the SAVER management system may be configured to employ, manage, and/or otherwise integrate with a SAVER analysis model and/or a SAVER assignment optimization model.

The SAVER analysis model may be configured to receive and/or retrieve data associated with one or more SAVERs in order to determine various SAVER attributes (e.g., strengths, weaknesses, skillsets, abilities, productivity metrics) based on performance evaluation data, colleague feedback data, training record data, skill assessment results, and/or historical vulnerability detection results generated based on previously assigned software application evaluation tasks, and/or the like associated with the one or more respective SAVERs. A SAVER profile may further comprise identification data, workload data, availability data, evaluation toolset data and/or the like associated with a respective SAVER. Moreover, the SAVER analysis model may be configured to generate and/or update one or more SAVER profiles based on such data. The one or more SAVER profiles may be utilized by the SAVER assignment optimization model to determine an appropriate SAVER to execute a respective software application evaluation task.

In this regard, the SAVER assignment optimization model may be configured to utilize a set of evaluation task requirements associated with the respective software application evaluation task, and a set of one or more SAVER profiles. An optimization problem may be formulated and executed that aims to assign software application evaluation tasks to SAVERs while both maximizing their strengths and minimizing the impact of their weaknesses. Depending on the type of software application evaluation tasks, various attributes (e.g., various skillsets, strengths) of a SAVER profile may be weighed more heavily than others. For example, a metric may be determined to find a quality versus quantity balance. While a higher quantity of findings may reflect thoroughness, a SAVER with a greater quality of findings (e.g., in relation to severity of a vulnerability of a software application) may be more desirable for a particular software application evaluation task.

Furthermore, the SAVER assignment optimization model may be configured to determine a set of evaluation task constraints associated with a respective software application evaluation task. The set of evaluation task constraints may also be applied by the SAVER assignment optimization model to ensure the appropriate SAVER is chosen to execute the respective software application evaluation task. As such, the SAVER management system may leverage the set of ML models to ingest, parse, and/or analyze thousands, even millions, of data points in order to optimize the utilization of one or more SAVERs to evaluate, test, and/or assess a specific software application-a technological implementation that cannot be performed by conventional software application evaluation and/or testing systems, nor by human operators.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for incorporating a SAVER management system.

FIG. 2 illustrates a schematic block diagram of example circuitry embodying a system device that may perform various operations in accordance with some example embodiments described herein.

FIG. 3 illustrates an example dataflow diagram for providing SAVER optimization in accordance with some example embodiments described herein.

FIG. 4 illustrates an example dataflow diagram for determining a second SAVER to execute a second software application evaluation task in accordance with some example embodiments described herein.

FIG. 5 illustrates an example flowchart diagram for determining an evaluation toolset with which to execute a given software application evaluation task in accordance with some example embodiments described herein.

FIG. 6 illustrates an example flowchart diagram for determining one or more training opportunities for a respective SAVER in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “user device,” “enterprise computing device,” or “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), embedded computers, and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

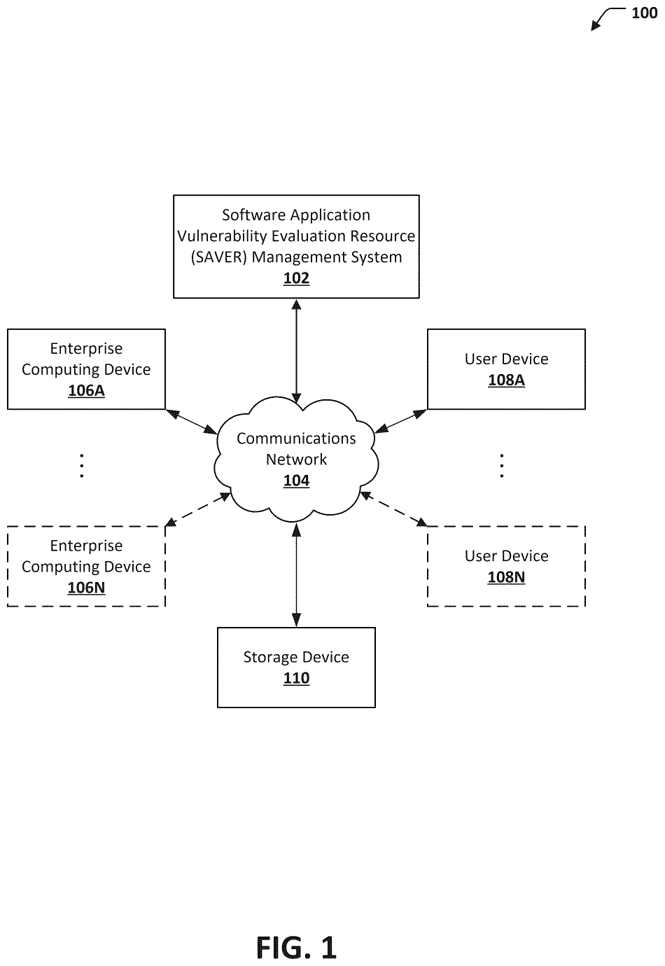

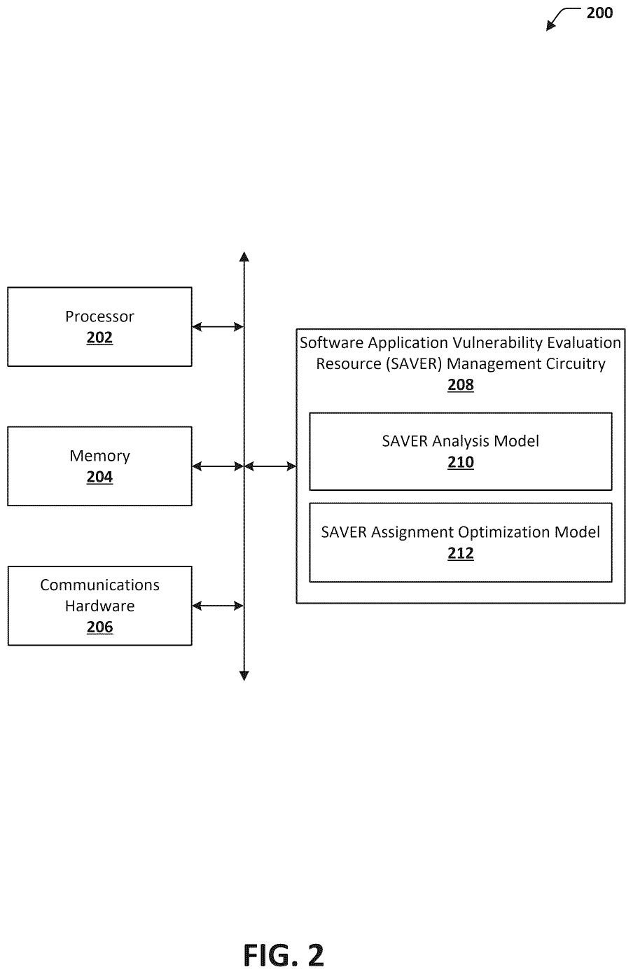

Example embodiments described herein may be implemented using any of a variety of computing devices or servers. To this end, FIG. 1 illustrates an example environment 100 within which various embodiments may operate. As illustrated, a SAVER management system 102 may receive and/or transmit information via communications network 104 (e.g., a telecommunications network (e.g., 5G network), wide area network (WAN), local area network (LAN), wireless Internet network, and/or the like capable of facilitating remote network communications) with any number of other devices, such as one or more of enterprise computing devices 106A-106N and/or user devices 108A-108N. The SAVER management system 102 may be implemented as one or more computing devices or servers, which may be composed of a series of components. Particular components of the SAVER management system 102 are described in greater detail below with reference to apparatus 200 in connection with FIG. 2.

In various embodiments, the SAVER management system 102 may be associated with an enterprise (e.g., a financial institution, bank, and/or the like) and may be configured to manage various SAVER optimization processes for said enterprise. For example, the SAVER management system 102 may be configured to manage, execute, initiate, and/or otherwise facilitate one or more software application evaluation task generation processes, SAVER assignment processes, SAVER profile generation and update processes, SAVER toolset identification processes, software application security enhancement processes, ML model training and refinement processes, enterprise data management processes, and/or the like for a respective enterprise. In one or more embodiments, the SAVER management system 102 may be configured to mitigate one or more vulnerabilities associated with a software application received from one or more computing devices associated with the one or more users (e.g., enterprise computing devices 106A-106N, user devices 108A-108N, and/or the like) via the communications network 104.

In various examples, the SAVER management system 102 may be configured receive software applications in various formats and from various sources. For example, the SAVER management system 102 may be configured to receive and execute one or more source code files comprising executable program code written in various programming languages (e.g., procedural programming languages, object-oriented programming languages (OOP), scripting languages, logical programming languages, functional programming languages, front-end languages, and/or back-end languages. Additionally or alternatively, the SAVER management system 102 may be configured to receive one or more programmatic references or addresses, hyperlinks, and/or the like associated with a software application (e.g., an actively hosted website).

In some examples, various users associated with an enterprise may interact with the SAVER management system 102 via a software application instance, where the software application instance may be configured to facilitate one or more of the various SAVER optimization processes described herein. In various embodiments, the software application instance associated with the SAVER management system 102 may be installed and/or downloaded to an enterprise computing device (e.g., an enterprise computing device 106A) and may present one or more user interface configurations to a respective user. As such, the software application instance associated with the SAVER management system 102 may be configured to guide a user through the various steps of a SAVER optimization process.

For example, the software application instance associated with the SAVER management system 102 may be configured to cause display of various interactive user interface elements to the user to facilitate the retrieval of a software application. Additionally, in various embodiments, the software application instance associated with the SAVER management system 102 may be configured to enable a user to access a software application framework related to a respective enterprise by, for example, granting (e.g., transmitting, enabling, toggling, configuring, etc.) one or more access permissions for an enterprise computing device (e.g., an enterprise computing device 106A) associated with the user, where the one or more access permissions enable the user device to access the software application framework associated with the enterprise.

In some embodiments, the SAVER management system 102 includes, embodies, and/or otherwise integrates with one or more of a SAVER analysis model and/or a SAVER assignment optimization model configured to facilitate one or more of the various SAVER optimization operations described herein. In various embodiments, the SAVER analysis model and/or the SAVER assignment optimization model may be configured to execute various ML, machine vision (MV), artificial intelligence (AI), generative AI, natural language processing (NLP), and/or optical character recognition (OCR) techniques. For example, the SAVER analysis model may be configured to process and/or extract various data features associated with a respective SAVER (e.g., software penetration tester, software security professional, software developer, white hat hacker, automated software application testing system, and/or the like) in order to determine various attributes, metrics, specializations, efficiencies, skillsets, and/or the like associated with the SAVER. The SAVER analysis model may employ such data in order to generate a SAVER profile associated with the respective SAVER.

In various examples, the SAVER analysis model and/or the SAVER assignment optimization model may be a supervised or unsupervised model and may be configured as an artificial neural network (ANN), recurrent neural network (RNN), convolutional neural network (CNN), long short-term memory (LSTM) network, non-linear optimization model, multi-objective optimization model, transformer model, rules-based model, or any other suitable deep learning model. For example, the SAVER assignment optimization model may be a non-linear optimization model configured to determine the best SAVER of a set of SAVERs to execute one or more specific software application evaluation tasks based on their particular attributes and efficiency and the various evaluation task requirements associated the one or more specific software application evaluation tasks. These and other operations executed by the SAVER analysis model and/or the SAVER assignment optimization model will be described in greater detail herein below with reference to FIGS. 2-6.

In some embodiments, the SAVER management system 102 may train (e.g., initially, periodically, iteratively, etc.) a supervised SAVER analysis model and/or a supervised SAVER assignment optimization model using supervised training techniques (e.g., using labeled training data, classification, regression, etc.) described herein to perform one or more operations described in further detail in connection with FIGS. 2-6. In other embodiments, the SAVER management system 102 may train (e.g., initially, periodically, iteratively, etc.) an unsupervised SAVER analysis model and/or an unsupervised SAVER assignment optimization model using unsupervised training techniques (e.g., using unlabeled training data, clustering, association, etc.) described herein to perform one or more operations described in further detail in connection with FIGS. 2-6. In this regard, the SAVER management system 102 may be configured to embody and/or integrate with one or more discrete ML models configured to perform specific tasks associated with the methods described herein.

In some embodiments, the SAVER management system 102 further includes a storage device 110 that comprises a distinct component from other components of the SAVER management system 102. The storage device 110 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Additionally or alternatively, the storage device 110 may host the software executed to operate the SAVER management system 102. Additionally or alternatively, the storage device 110 may store information relied upon during operation of the SAVER management system 102, such as various SAVER data (e.g., SAVER profile data), software application evaluation task data, ML model input data, ML model output data, ML training data, enterprise data (e.g., software application data, product and/or service data, distribution data, logistical data, legal data, software application framework data, etc.), and/or the like configured in various data formats to be utilized by the SAVER management system 102. In addition, the storage device 110 may store control signals, device characteristics, and/or access credentials enabling interaction between the SAVER management system 102 and/or one or more of the enterprise computing devices 106A-106N or user devices 108A-108N.

In various embodiments, the one or more enterprise computing devices 106A-106N and/or the one or more user devices 108A-108N may be embodied by any computing devices known in the art. The one or more enterprise computing devices 106A-106N and/or the one or more user devices 108A-108N need not themselves be independent devices but may be peripheral devices communicatively coupled to other computing devices.

### Example Implementing Apparatus

The SAVER management system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 2-6. As illustrated in FIG. 2, the apparatus 200 may include processor 202, memory 204, communications hardware 206, and/or SAVER management circuitry 208, each of which will be described in greater detail below.

The processor 202 (and/or co-processor or any other processor assisting or otherwise associated with the processor) may be in communication with the memory 204 via a bus for passing information amongst components of the apparatus 200. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204, the storage device 110, or otherwise accessible to the processor. In some cases, the processor may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

The memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, and/or the like for enabling the apparatus 200 to carry out various functions in accordance with example embodiments contemplated herein.

The communications hardware 206 may be any means such as a device or circuitry embodied in either hardware or a combination of hardware and software that is configured to receive and/or transmit data from/to a network (e.g., communications network 104) and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, software application instance, dedicated client device, or the like. In some embodiments, the communications hardware 206 may include a keyboard, a mouse, a touch screen, touch areas, soft keys, a microphone, a camera, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

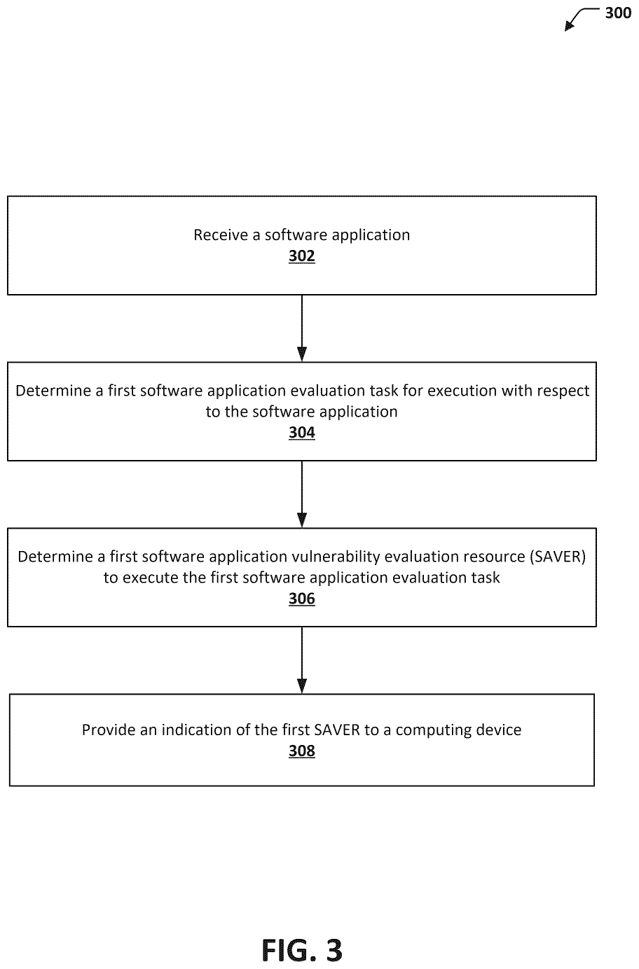

In addition, the apparatus 200 further comprises SAVER management circuitry 208. In some embodiments, the SAVER management circuitry 208 may be configured to facilitate the execution of one or more SAVER optimization operations for an enterprise associated with the SAVER management system 102. As such, the SAVER management circuitry 208 may utilize the communications hardware 206 to gather data from, or transmit data to, a variety of sources (e.g., the enterprise computing devices 106A-106N, the user devices 108A-108N, social media networks, consumer banking servers, and/or any storage devices (e.g., storage device 110) associated with the SAVER management system 102), and/or exchange data with a user. Additionally, the SAVER management circuitry 208 may utilize processor 202, memory 204, or any other hardware component included in the apparatus 200 (e.g., one or more cameras, global positioning service (GPS) devices, and/or the like) to perform these operations, as described in connection with FIGS. 3-6 below.

In various embodiments, the SAVER management circuitry 208 may be configured to automatically initiate and/or execute various software vulnerability scans on a respective software application including, but not limited to, a software composition analysis (SCA), static application security testing (SAST), dynamic application security testing (DAST), interactive application security testing (IAST), and/or the like to detect one or more vulnerabilities (or potential vulnerabilities) associated with a respective software application. In some examples, the various software vulnerability scans may detect one or more third-party components (e.g., executable program code modules, functions, methods, libraries, application programming interfaces (API), and/or the like) that are subject to one or more known exploitations. As a non-limiting example, the SAVER management circuitry 208 may facilitate the execution of a vulnerability scan that detects third-party components with known serialization vulnerabilities (e.g., code injection attacks, remote code execution (RCE), data tampering, denial of service (DoS), and/or the like and generate one or more software application evaluation tasks based on the detected third-party components.

A software application evaluation task may be a recommended course of action, evaluation, test (e.g., a software penetration test, exploit), analysis, inquiry, inspection, investigation, and/or the like to be executed with respect to one or more software components of a respective software application. A software application evaluation task may be configured to determine (e.g., detect, identify, exploit, evaluate, investigate, test) one or more potential vulnerabilities, security risks, threats, and/or the like associated with a respective software application that may lead to the loss of sensitive data, resources, information, access, control, management, and/or the like associated with an enterprise and/or one or more users. In some examples, a software application evaluation task may be configured to ensure that a particular software application satisfies one or more data security regulations and/or standards (e.g., government-imposed regulations, international regulations, privacy regulations).

As such, the SAVER management system 102 may assign (e.g., delegate, select, identify) one or more SAVERs to execute various respective software application evaluation tasks in order to determine whether one or more components of a software application may be at risk of being exploited by bad actors trying to illicitly obtain data and/or access to data. For example, upon executing a particular software application evaluation task, a SAVER may determine that a bad actor could potentially exploit a particular component of the software application to gain access to sensitive data and/or a software application framework associated with an enterprise (e.g., by elevating access permissions and illegally accessing the sensitive data and/or software application framework. Based on vulnerability detection results generated by the SAVER based on executing one or more software application evaluation tasks, a responsible entity (e.g., a software developer, project lead) may be enabled to fix, secure, quarantine, reprogram and/or otherwise mitigate any detected vulnerabilities and/or security risks associated with one or more components of the software application.

Furthermore, in various embodiments, the SAVER management circuitry 208 may be configured to leverage the processor 202, the memory 204, and/or the communications hardware 206 to generate, cause transmission of, and/or cause display of a plurality of interactive user interface elements on a user interface associated with a software application instance associated with the SAVER management system 102 on a computing device (e.g., enterprise computing device 106A. The plurality of interactive user interface elements may be configured as one or more interactive text fields, buttons, selectable images, hyperlinks, radio buttons, sliders, embedded multimedia modules, charts, graphs, prompts, notifications, banners, instructions, and/or the like configured to initiate execution of one or more commands (e.g., executable software instructions) designed to facilitate the capture of one or more portions of user input.

In this regard, the SAVER management circuitry 208 may be configured to leverage a plurality of interactive user interface elements in order to communicate (e.g., display) an indication that a respective has been selected (e.g., assigned, chosen, delegated) to execute one or more software application evaluation tasks associated with one or more respective software applications. For example, the SAVER management circuitry 208 may be configured to cause display of an indication of a respective SAVER on the user interface associated with the software application instance associated with the SAVER management system 102. In some example embodiments, the indication of the respective SAVER determined to execute one or more software application evaluation tasks may comprise various data related to a SAVER profile associated with the SAVER and/or one or more portions of data related to the one or more software application evaluation tasks related to a respective software application to which the SAVER has been assigned.

In various examples, the SAVER management circuitry 208 may work in conjunction with (e.g., may direct, manage, embody, and/or otherwise integrate with) a SAVER analysis model 210 and/or a SAVER assignment optimization model 212 in order to execute one or more of the methods described herein. As such, the SAVER management circuitry 208 may be configured to facilitate the transfer of various model input and/or model output to the SAVER analysis model 210 and/or the SAVER assignment optimization model 212. Furthermore, the SAVER management circuitry 208 may be configured to facilitate the training, updating, retraining, and/or refining of the SAVER analysis model 210 and/or the SAVER assignment optimization model 212.

The SAVER analysis model 210 may be configured leverage one or more NLP, OCR, and/or image data analysis techniques to process and/or extract various data features associated with one or more respective SAVERs (e.g., software penetration testers, software security professionals, software developers, white hat hackers, automated software application testing systems, and/or the like) in order to determine various attributes, metrics, specializations, efficiencies, skillsets, and/or the like associated with the one or more respective SAVERs with which to generate SAVER profiles for the one or more respective SAVERs. In various embodiments, the SAVER analysis model 210 may be configured to extract and/or otherwise process text data (e.g., text string data, text content, words, phrases, substring data, etc.), text placement data (e.g., paragraph styles, text placement and/or position relative to the overall document, etc.), text format data (e.g., fonts, emphasis, styles, etc.), image data (e.g., image placement, image content, etc.), encoded authentication objects (e.g., QR codes, barcodes, watermarks, document identification codes, etc.) to determine various data features associated with the SAVER. Additionally or alternatively, the SAVER analysis model 210 may be configured to extract data features from digital correspondence associated with two or more SAVERs (e.g., chat data, message board “thread” data, email data, SMS message data, etc.), hyperlink data (e.g., web address data), known evaluation toolset inventory data, interactive user interface element data (e.g., HTML data, control element data (e.g., buttons, sliders, etc.)), image metadata, and/or the like. Such data may be utilized by the SAVER analysis model 210 to generate a SAVER profile for a respective SAVER.

The SAVER assignment optimization model 212 may be configured to optimize the selection of one or more SAVERs to execute one or more respective software application tasks associated with one or more respective software applications. In some examples, the SAVER assignment optimization model 212 may be configured as an RNN designed to determine a most appropriate (e.g., most qualified, most proficient, most efficient) SAVER of a set of SAVERs to execute one or more software application evaluation tasks. Additionally or alternatively, the SAVER assignment optimization model 212 may be configured to employ various non-linear and/or multi-objective optimization techniques to determine an appropriate SAVER for a respective software application evaluation task. As such, the SAVER assignment optimization model 212 may be configured to maximize the number of vulnerabilities found in a respective software application while simultaneously minimizing the amount of time that it takes to find them by intelligently assigning one or more SAVERs to execute one or more software application evaluation tasks related to a respective software application.

Although components 202-212 are described in part using functional language, it will be understood that the particular implementations necessarily include the use of particular hardware. It should also be understood that certain of these components 202-212 may include similar or common hardware. For example, the SAVER management circuitry 208, the SAVER analysis model 210, and/or the SAVER assignment optimization model 212 may each at times leverage use of the processor 202, memory 204, and/or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may, in addition, refer to software instructions that configure the hardware components of the apparatus 200 to perform the various functions described herein.

Although the SAVER management circuitry 208, the SAVER analysis model 210, and/or the SAVER assignment optimization model 212 may leverage processor 202, memory 204, and/or communications hardware 206 as described above, it will be understood that any of the SAVER management circuitry 208, the SAVER analysis model 210, and/or the SAVER assignment optimization model 212 may include one or more dedicated processors, specially configured field programmable gate arrays (FPGA), or application specific interface circuits (ASIC) to perform its corresponding functions, and may accordingly leverage processor 202 for executing software stored in a memory (e.g., memory 204), or communications hardware 206 for enabling any functions not performed by special-purpose hardware. In all embodiments, however, it will be understood that the SAVER management circuitry 208, the SAVER analysis model 210, and/or the SAVER assignment optimization model 212 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of an example apparatus 200, example embodiments are described below in connection with a series of flowcharts.

### Example Operations

Turning to FIGS. 3-6, example flowcharts are illustrated that contain example operations implemented by example embodiments described herein. The operations illustrated in FIGS. 3-6 may, for example, be performed by a system device (e.g., server, etc.) of the SAVER management system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, SAVER management circuitry 208, SAVER analysis model 210, SAVER assignment optimization model 212, and/or any combination thereof. It will be understood that user interaction with the SAVER management system 102 may occur directly via communications hardware 206 or may instead be facilitated by a separate computing device (e.g., any of enterprise computing devices 106A-106N, and/or user devices 108A-108N shown in FIG. 1), and which may have similar or equivalent physical componentry facilitating such user interaction.

Turning first to FIG. 3, the flowchart 300 illustrates example operations for providing SAVER optimization.

As shown by operation 302, the apparatus 200 may include means, such as processor 202, memory 204, communications hardware 206, SAVER management circuitry 208, and/or the like for receiving a software application. As described herein, the SAVER management system 102 may be configured to leverage the communications hardware 206 to receive software applications in various formats and from various sources. For example, the SAVER management system 102 may be configured to receive, mount, and/or execute one or more source code files comprising executable program code written in various programming languages (e.g., procedural programming languages, object-oriented programming languages (OOP), scripting languages, logical programming languages, functional programming languages, front-end languages, and/or back-end languages.

In some examples, the SAVER management system 102 may be configured to receive a software application (e.g., by way of the communications hardware 206) and execute and/or evaluate the software application locally on a respective computing device (e.g., enterprise computing device 106A). In other examples, the SAVER management system 102 may be configured to execute and/or evaluate a software application remotely over a network (e.g., communications network 104). In this regard, the SAVER management system 102 may be configured to receive one or more programmatic references or addresses, hyperlinks, and/or the like associated with a software application (e.g., an actively hosted website). As such, the SAVER management system 102 may be configured to utilize the one or more programmatic references to remotely access, execute, and/or evaluate the software application over a network.

As shown by operation 304, the apparatus 200 may include means, such as processor 202, memory 204, communications hardware 206, SAVER management circuitry 208, SAVER analysis model 210, SAVER assignment optimization model 212, and/or the like for determining a first software application evaluation task of a set of software application evaluation tasks for execution with respect to the software application. For example, in order to determine (e.g., generate, select, identify) the first software application evaluation tasks, the SAVER management circuitry 208 may be configured to automatically initiate and/or execute various software vulnerability scans on the respective software application including, but not limited to, an SCA, SAST, DAST, IAST, and/or the like to detect one or more vulnerabilities (or potential vulnerabilities) associated with the respective software application. In some examples, the various software vulnerability scans may detect one or more third-party components (e.g., executable program code modules, functions, methods, libraries, APIs, and/or the like) that are subject to one or more known exploitations. For example, the SAVER management circuitry 208 may facilitate the execution of a vulnerability scan that detects third-party components with known serialization vulnerabilities (e.g., code injection attacks, RCE attacks, data tampering, DOS attacks, and/or the like and generate the first software application evaluation task based on the detected third-party components.

Additionally or alternatively, in various examples, the SAVER management circuitry 208 may be configured to determine the first software application evaluation task to be executed with respect to a particular software application based on determining a programming framework and/or a set of programming languages used to construct and/or configure the software application (aka. a software application's technology stack). Additionally or alternatively, in some examples, the SAVER management circuitry 208 may be configured to determine the first software application evaluation task to be executed with respect to a particular software application based on determining a native computing device type and/or operating system (OS) or platform on which the software application is intended to run (e.g., Android OS on a smartphone, Apple OS (macOS) on a laptop, Apple iOS on an iPhone, an embedded computing system in a kiosk (e.g., an ATM), and/or the like).

In various examples, the SAVER management circuitry 208 may be configured to determine a set of evaluation task requirements for the first software application evaluation task. The set of evaluation task requirements may comprise one or more of a necessary or recommended specialization (e.g., skillset, certification, ability), evaluation toolset, evaluation type (e.g., evaluation exploit type, test type), technological capability (e.g., particular software or hardware capabilities), and/or the like with which to execute the first software application evaluation task. Additionally or alternatively, the set of evaluation task requirements may comprise data related a timeframe with which to execute the first software application evaluation task (e.g., a deadline), and/or one or more characteristics (e.g., descriptions) associated with the first software application evaluation task describing one or more vulnerabilities and/or security risks which the first software application evaluation task has been generated to evaluate and/or mitigate.

Additionally, in some examples, the SAVER assignment optimization model 212 may be configured to determine a set of evaluation task constraints associated with the first software application evaluation task. The set of evaluation task constraints may comprise data related to one or more of a workload (e.g., a work docket, current number of hours worked, or work limitations) and/or availability (e.g., work schedule, meeting schedule, vacation schedule, paid time off (PTO) data) of one or more SAVERS that are qualified to execute the first software application evaluation task. The set of evaluation task constraints may further comprise data related to one or more deadlines associated with the first software application evaluation task. Additionally or alternatively, set of evaluation task constraints may further comprise data related to a level of criticality (e.g., data risk severity, exploitation risk severity) associated with one or more vulnerabilities and/or security risks to be mitigated via execution of the first software application evaluation task and/or a priority level (e.g., level of importance, urgency) of the first software application evaluation task as it relates to one or more other software application evaluation tasks associated with the software application.

As shown by operation 306, the apparatus 200 may include means, such as processor 202, memory 204, communications hardware 206, SAVER management circuitry 208, SAVER analysis model 210, SAVER assignment optimization model 212, and/or the like for determining a first SAVER to execute the first software application evaluation task. For example, the SAVER assignment optimization model 212 may be configured to determine the first SAVER to execute the first software application evaluation task based on a SAVER profile associated with the first SAVER and/or a first set of evaluation task constraints associated with the first software application evaluation task. As described herein, in some examples, the first SAVER may be a human such as a software penetration tester, software security professional, software developer, white hat hacker, and/or the like. Alternatively, as described herein, the first SAVER may be an automated software application testing system configured to execute one or more software application evaluation tasks. In such examples, an automated software application testing system may be configured to generate various vulnerability detection results based on executing one or more software application evaluation tasks with respect to a particular software application.

In various examples, the SAVER analysis model 210 may be configured to process and/or extract various data features from performance evaluation data, colleague feedback data, training record data, skill assessment results, and/or historical vulnerability detection results generated based on previously assigned software application evaluation tasks, and/or the like associated with one or more respective SAVERs. Additionally or alternatively, in some examples, the SAVER analysis model 210 may be configured to employ various NLP, OCR, and/or image data analysis techniques to parse and/or analyze a skills matrix associated with a respective SAVER in order to process and/or extract various data features associated with the competencies, skillsets, specializations, certifications, work experience, soft skills, and/or the like associated with the respective SAVER. In some examples, one or more of the competencies, skillsets, specializations, certifications, work experience, soft skills, and/or the like comprised in the skills matrix may be associated with a score and/or a rank (e.g., a numerical value defined with a predetermined range of values (e.g., 0.0-1.0, 1-10, or any other numerical range)), where the score and/or the rank may indicate a degree of competency, proficiency, or the like associated with a particular specialization, certification, skill, work experience, or the like comprised in the skills matrix.

Based on such extracted data features, the SAVER analysis model 210 may be configured to determine various SAVER attributes (e.g., strengths, weaknesses, skillsets, abilities, productivity metrics) associated with one or more respective SAVERs. The SAVER attributes may indicate one or more software application evaluation tasks a respective SAVER may be adept at executing. Similarly, the SAVER attributes may indicate one or more software application evaluation tasks a respective SAVER may be inept (e.g., inefficient, incapable) at executing. This data may be granular and may also include a quality of a SAVER's findings (e.g., accuracy, depth, and relevance of vulnerability detection results generated with respect to any vulnerabilities and/or potential security risks within a software application discovered by the SAVER). Additionally, this data may also include a quantity of a SAVER's findings (e.g., a total number of vulnerabilities and/or potential risks within a software application discovered by the SAVER), and/or a severity of factors (e.g., a level of risk and/or potential impact of a detected vulnerability associated with a software application).

As such, the SAVER analysis model 210 may be configured to determine the proficiency and the efficiency of a respective SAVER relative to the various types of evaluation exploits (e.g., penetration tests, stress tests, vulnerability tests) they may be equipped to execute. For example, the SAVER analysis model 210 may be configured to rate the proficiency of a SAVER relative to a particular evaluation exploit based on the data features associated with a SAVER profile related to the SAVER. Furthermore, the SAVER analysis model 210 may be configured to determine a rate of vulnerability identification (aka. a hit rate) in terms of how many exploitable vulnerabilities they identify with respect to various types of software applications via various evaluation exploits. An evaluation exploit may be implemented as executable program code designed to expose and/or take advantage of a vulnerability (e.g., a cybersecurity flaw, unintentional access point, application design flaw) associated with a software application to gain access to or control of a system, or to steal data and/or disrupt the operation of a software application or related software application framework. In some examples, evaluation exploits may be configured to attack, leverage, and/or otherwise expose password vulnerabilities, user authentication issues (e.g., multifactor authentication (MFA) vulnerabilities, account authentication issues, device authentication issues, privileged access vulnerabilities), software misconfiguration vulnerabilities, cross-site scripting (XXS) vulnerabilities, OS vulnerabilities, third-party component vulnerabilities, software application authorization vulnerabilities, and/or the like.

Some evaluation exploits may be RCE exploits (e.g., SQL injection, XXS, remote file inclusion (RFI)) configured to execute program code on a remote system, DoS exploits design to overwhelm a computer system by causing excess network traffic through the system and/or consuming excess computational resources, file inclusion exploits configured to input malicious program code into a software application to be executed by a computer system, privilege escalation exploits designed to gain elevated access permissions to a computer system, man-in-the-middle (MitM) exploits to intercept and/or corrupt communications, buffer overflow exploits, and/or the like. In some examples, one or more evaluation exploits may be associated with the MITRE ATT&K® knowledge base.

In addition to the SAVER attributes associated with a respective SAVER, a SAVER profile may also comprise identification data (e.g., employee ID numbers, contact information, user device identification data), workload data (e.g., a current work docket, a number of hours worked, work limitations), availability data (e.g., a work schedule, calendar, vacation schedule, PTO data), evaluation toolset data, and/or the like associated with a respective SAVER. The evaluation toolset data associated with the SAVER profile may indicate one or more evaluation toolsets with which the SAVER is familiar and/or is competent in utilizing to detect and/or analyze various vulnerabilities associated with a respective type of software application. In some examples, the evaluation toolset data may indicate that the SAVER has built, configured, developed and/or otherwise manages one or more respective evaluation toolsets. In some examples, an evaluation toolset may be a software program or software module comprising a set of executable scripts and/or executable program code associated with a particular type of evaluation exploit that is configured to evaluate (e.g., intentionally exploit, stress test, inspect, analyze, and/or manipulate) one or more software components (e.g. third-party components, proprietary components), features, plugins, extensions, inputs (e.g., text fields, search bars), interactive user interface elements, and/or the like associated with a respective software application that may be vulnerable to abuse by a bad actor.

As such, the SAVER assignment optimization model 212 may be configured to determine the first SAVER to execute the first software application evaluation task based on the various attributes comprised within the SAVER profile associated with the first SAVER. For example, the SAVER assignment optimization model 212 may determine that a second SAVER is not proficient at writing scripts (e.g., scripts to be used as injection exploits to evaluate a software application) as the first SAVER but is very efficient at identifying unnecessary (e.g., potentially dangerous) scripts in existing source code. The SAVER assignment optimization model 212 may also determine that the first SAVER is proficient in writing scripts to administer various exploits but is less efficient at detecting existing (e.g., unnecessary, dangerous) scripts in source code. As such, the SAVER assignment optimization model 212 may determine that the first SAVER is a better fit than the second SAVER for a first software application evaluation task, and vice versa for a second software application evaluation task.

In this regard, the SAVER assignment optimization model 212 may be configured to employ various non-linear and/or multi-objective optimization techniques to determine an appropriate SAVER for a respective software application evaluation task. As such, the SAVER assignment optimization model 212 may be configured to maximize the number of vulnerabilities found in a respective software application while simultaneously minimizing the amount of time that it takes to find them. In some examples, a user may be enabled to input preferences (e.g., model constraints) into the software application instance associated with the SAVER management system 102 in order to mitigate the tradeoff between efficiency and quality while determining SAVERs to assign to various software application evaluation tasks. For example, in some embodiments, the SAVER assignment optimization model 212 may be configured to more heavily weight certain attributes associated with a set of SAVERs (e.g., attributes associated with efficiency), and more lightly weight other attributes (e.g., attribute associated with proficiency), such that SAVERs who are more efficient and/or may identify a larger quantities vulnerabilities are chosen for certain software application evaluation tasks instead of SAVERs who may produce higher quality findings but at a slower pace.

In some examples, the SAVER assignment optimization model 212 may take in multiple inputs in order to determine an appropriate SAVER out of a set of SAVERs to execute a particular software application evaluation task. For example, the SAVER assignment optimization model 212 may determine a SAVER based on a set of evaluation task requirements associated with a particular software application evaluation task, a set of evaluation task constraints associated with a particular software application evaluation task, and/or one or more SAVER profiles associated with the one or more respective SAVERs in the set of SAVERs.

Furthermore, referencing again operation 306, the SAVER assignment optimization model 212 may determine a second SAVER to execute the first software application evaluation task in conjunction with the first SAVER. For example, based on the first set of evaluation task requirements (e.g., SAVER specialization requirements, evaluation toolset knowledge requirements) associated with the first software application evaluation task, the SAVER assignment optimization model 212 may determine two or more SAVERs that are optimal matches for executing the first software application evaluation task. Additionally or alternatively, based on the first set of evaluation task constraints (e.g., deadline constraints, criticality constraints), the SAVER assignment optimization model 212 may determine that two or more SAVERs are needed to execute the first software application evaluation task in tandem.

As shown by operation 308, the apparatus 200 may include means, such as processor 202, memory 204, communications hardware 206, and/or the like for providing an indication of the first SAVER to a computing device. In some examples, the indication of the first SAVER may be a digital notification (e.g., SMS message, direct message in the software application instance associated with the SAVER management system 102), alert, and/or digital correspondence (e.g., email) configured to be provided to one or more computing devices (e.g., one or more of enterprise computing devices 106A-106N) associated with one or more respective entities (e.g., the first SAVER, a software developer, project lead, and/or the like associated with the SAVER management system 102). The indication of the first SAVER may be configured to describe the first software application evaluation task, the first set of evaluation task requirements associated with the first software application evaluation task, the first set of evaluation task constraints, and/or one or more reasons why the first SAVER was selected to execute the first software application evaluation task. For example, the indication of the first SAVER may describe one or more attributes associated with the first SAVER (e.g., attributes derived from the SAVER profile of the first SAVER related to first SAVER's efficiency and/or proficiency) and/or one or more reasons (e.g., availability, current workload) the first SAVER was selected to execute the first software application evaluation task.

In some examples, providing indication of the first SAVER comprises determining contact information associated with the SAVER (e.g., email address, phone number, employee ID) and transmitting a work order associated with the first software application evaluation task to a computing device (e.g., user device 108A) associated with the SAVER. In this regard, the SAVER management circuitry 208 may be configured to generate and/or cause transmission of a work order (e.g., a digital document, digital correspondence) that describes the respective software application, the first set of evaluation task requirements, and/or the first set of evaluation task constraints associated with the first software application evaluation task. Additionally, in some examples, the work order may describe various contractual obligations, due dates, managing personnel, responsible parties, and/or the like associated with the first software application evaluation task, the SAVER, and/or the enterprise for which the SAVER is beholden to. Additionally or alternatively, in various embodiments, the work order associated with the first software application evaluation task may be interactive (e.g., may comprise one or more interactive user interface elements such as a hyperlink and/or button) such that the first SAVER can provide acknowledgement of receipt of the work order. For example, an interaction with a hyperlink and/or button associated with the work order may cause the generation and/or transmission of an acknowledgement that the first SAVER has received the work order and has confirmed that the first software application evaluation task will be timely executed.

In examples in which the SAVER assignment optimization model 212 determines multiple (e.g., two or more) appropriate SAVERs to execute the first software application evaluation task, an indication of the multiple SAVERs may be generated and/or transmitted to a responsible party (e.g., a project lead associated with the first software application evaluation task). In such examples, the indication of the multiple SAVERs may indicate the relevant attributes and/or availabilities for which the multiple SAVERs were chosen. As such, the responsible party may then be enabled to choose which of the multiple SAVERs to execute the first software application evaluation task. For example, the software application instance associated with the SAVER management system 102 may be configured to display interactive user interface elements associated with the two or more respective SAVERs such that an interaction (e.g., selection indication) with the interactive user interface elements may cause the generation and/or transmission of a work order associated with the first software application evaluation tasks to one or more of the multiple SAVERs indicated by the SAVER assignment optimization model 212.

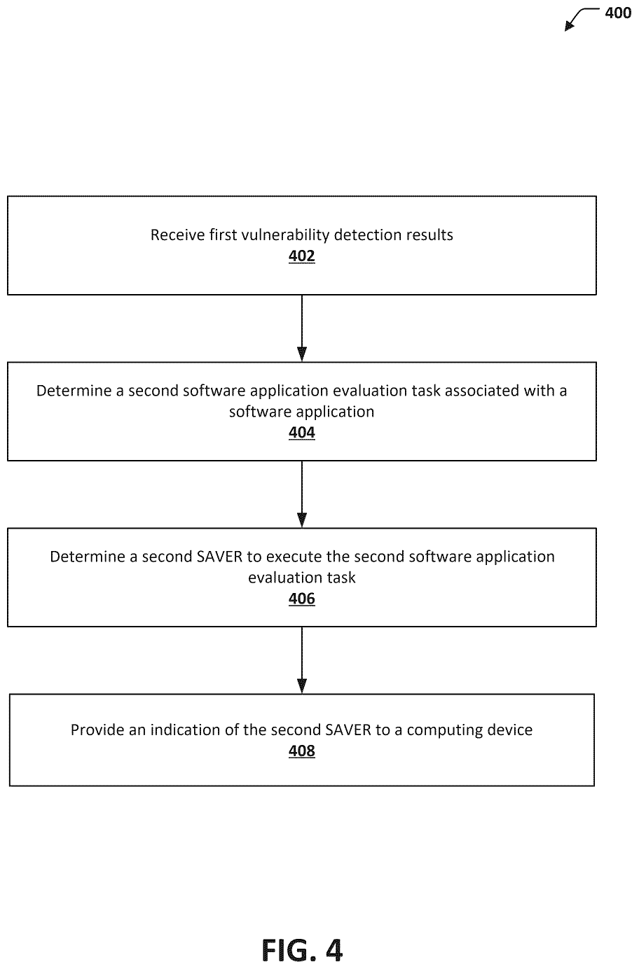

Turning next to FIG. 4, the flowchart 400 illustrates example operations for determining a second SAVER to execute a second software application evaluation task.

As shown by operation 402, the apparatus 200 may include means, such as processor 202, memory 204, communications hardware 206, and/or the like for receiving first vulnerability detection results generated in response to execution of a first software application evaluation task associated with a respective software application. Vulnerability detection results may be findings, determinations, analyses, and/or descriptions related to one or more vulnerabilities and/or security risks associated with the software application that were detected during execution of the first software application evaluation task. In various examples, vulnerability detection results may be configured in various structured or unstructured formats.

For example, upon execution of the first software application evaluation task by a first SAVER, the first SAVER may be enabled to fill out a structured digital form configured to describe any evaluation exploits, evaluation toolsets, tests, analyses, searches, and/or courses of action that were completed while executing the first software application evaluation task, as well as any findings, determinations, diagnoses, hypotheses, and/or results generated as a result. The structured digital form may be received (e.g., by the communications hardware 206) such that the first vulnerability detection results associated with the execution of the first software application evaluation task may be processed by the SAVER management system 102 (e.g., by the processor 202 and/or the SAVER management circuitry 208).

Alternatively, in other examples, the vulnerability detection results may be an unstructured and/or informal documentation of any evaluation exploits, evaluation toolsets, tests, analyses, searches, and/or courses of action that were completed by the first SAVER while executing the first software application evaluation task, as well as any findings, determinations, diagnoses, hypotheses, and/or results generated as a result. In such examples, the SAVER management system 102 (e.g., by the processor 202 and/or the SAVER management circuitry 208) be configured to apply one or more OCR and/or NLP techniques to parse and/or analyze the unstructured and/or informal documentation associated with the first vulnerability detection results generated by the first SAVER.

In some examples, the SAVER management circuitry 208 may be configured to cause storage of the first vulnerability detection results in a storage device (e.g., the storage device 110) for future access and/or processing by the various components of the SAVER management system 102. For example, the SAVER analysis model 210 may be configured to update a SAVER profile associated with the first SAVER based on the first vulnerability detection results generated based on execution of the first software application evaluation task and stored in the storage device 110. Additionally or alternatively, in some examples, the SAVER management circuitry 208 may be configured to cause the update, retraining, and/or refining of the SAVER assignment optimization model 212 based on the first vulnerability detection results generated based on execution of the first software application evaluation task and stored in the storage device 110.

As shown by operation 404, the apparatus 200 may include means, such as processor 202, memory 204, SAVER management circuitry 208, and/or the like for determining a second software application evaluation task associated with the software application. For example, the SAVER management circuitry 208 may determine a second evaluation task to be executed with respect to the software application based on the first vulnerability detection results generated based on execution of the first software application evaluation task. In some embodiments, the SAVER management circuitry 208 may utilize the first vulnerability detection results as an additional input while executing one or more additional software vulnerability scans.

Based on the first vulnerability detection results, the SAVER management circuitry 208 may determine additional vulnerabilities and/or security risk associated with one or more components of the software application that warrant additional evaluation and/or analysis. For example, the first software application evaluation task may have exposed the fact that various text fields and/or inputs associated with the software application may be vulnerable to script injection attacks by bad actors. In such an example, the SAVER management circuitry 208 may thus determine, based on the vulnerabilities, that the software application may also be susceptible to access permission escalation attacks via the unsecure text fields and/or inputs associated with the software application and therefore further evaluation is necessary. As such, the SAVER management circuitry 208 may determine one or more additional software application evaluation tasks (e.g., the second software application evaluation task) to be executed subsequent to the first software application evaluation task.

As shown by operation 406, the apparatus 200 may include means, such as processor 202, memory 204, communications hardware 206, SAVER assignment optimization model 212, and/or the like for determining a second SAVER to execute the second software application evaluation task. The second software application evaluation task may be associated with a second set of evaluation task requirements and/or a second set of evaluation task constraints. As such, the SAVER assignment optimization model 212 may be configured to determine the second SAVER to execute the second software application evaluation task based on the second set of evaluation task requirements, the second set of evaluation task constraints, and/or the respective SAVER profile associated with the second SAVER. In this regard, the SAVER assignment optimization model 212 may be configured to determine the second SAVER in a same or similar manner such as the one detailed in operation 306 described with reference to FIG. 3.

As shown by operation 408, the apparatus 200 may include means, such as processor 202, memory 204, communications hardware 206, SAVER management circuitry 208, SAVER analysis model 210, SAVER assignment optimization model 212, and/or the like for providing an indication of the second SAVER to a computing device. In some examples, the indication of the second SAVER may be a digital notification, alert, and/or digital correspondence configured to be provided to one or more computing devices (e.g., one or more of enterprise computing devices 106A-106N) associated with one or more respective entities (e.g., the second SAVER, a software developer, project lead, and/or the like). The indication of the second SAVER may be configured to describe the second software application evaluation task, the second set of evaluation task requirements associated with the second software application evaluation task, the second set of evaluation task constraints, and/or one or more reasons why the second SAVER was selected to execute the second software application evaluation task. For example, the indication of the second SAVER may describe one or more attributes associated with the second SAVER (e.g., attributes derived from the SAVER profile of the second SAVER related to the second SAVER's efficiency and/or proficiency) and/or one or more reasons (e.g., availability, current workload) the second SAVER was selected to execute the second software application evaluation task.

The SAVER management circuitry 208 may be configured to generate and/or cause transmission of a work order (e.g., a digital document, digital correspondence) that describes the respective software application, the second set of evaluation task requirements, and/or the second set of evaluation task constraints associated with the second software application evaluation task. Additionally, in some examples, the work order may describe various contractual obligations, due dates, managing personnel, responsible parties, and/or the like associated with the second software application evaluation task, the SAVER, and/or the enterprise for which the SAVER is beholden to. Additionally or alternatively, in various embodiments, the work order associated with the second software application evaluation task may be interactive (e.g., may comprise one or more interactive user interface elements such as a hyperlink and/or button) such that the second SAVER can provide acknowledgement of receipt of the work order. For example, an interaction with a hyperlink and/or button associated with the work order may cause the generation and/or transmission of an acknowledgement that the second SAVER has received the work order and has confirmed that the second software application evaluation task will be timely executed.

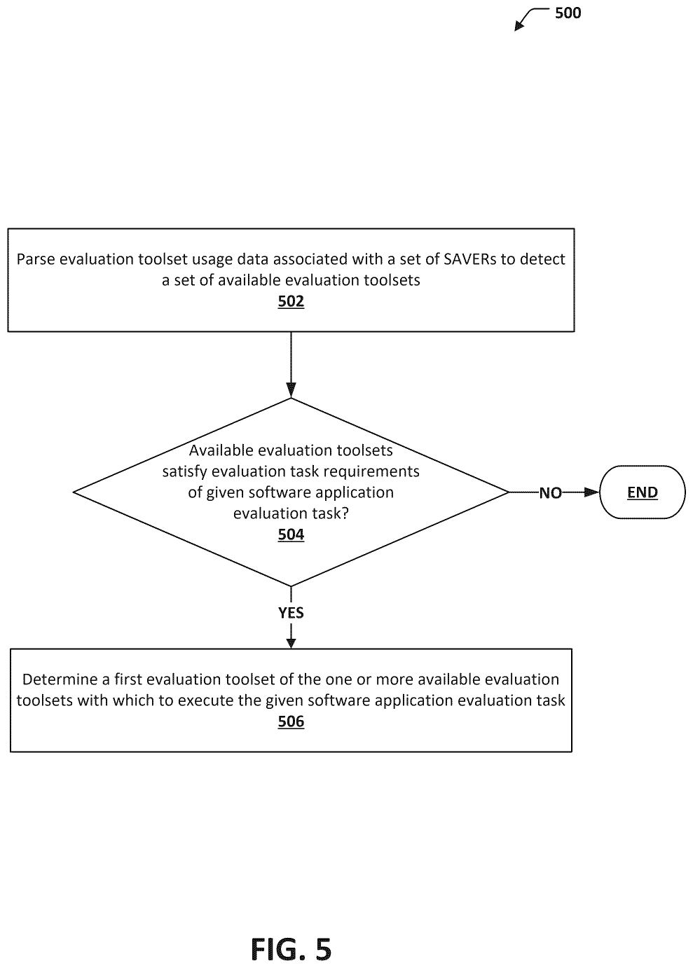

Turning next to FIG. 5, the flowchart 500 illustrates example operations for determining an evaluation toolset with which to execute a given software application evaluation task.

As shown by operation 502, the apparatus 200 may include means, such as processor 202, memory 204, SAVER analysis model 210, and/or the like for parsing evaluation toolset usage data associated with a set of SAVERs to detect a set of available evaluation toolsets. For example, the SAVER analysis model 210 may be configured to parse and/or analyze evaluation toolset usage data associated with one or more SAVERs to detect a set of available evaluation toolsets that may be deployable for completing one or more software application evaluation tasks. In some examples, the evaluation toolset usage data may be embodied and/or otherwise associated with various digital correspondence data associated with two or more SAVERs (e.g., chat data, message board thread data, email data, SMS message data, etc.) and/or known evaluation toolset inventory data.

The evaluation toolset usage data associated with the digital correspondence data may be self-reported data generated by one or more SAVERs that indicates the viability and/or applicability of various evaluation toolsets for given software application evaluation tasks. For example, a first SAVER may post a question and/or information request regarding a respective software application evaluation task on a message board (e.g., a message board on internal communications platform, a web-based message board), where the question and/or information request may be a request for help or advice related to methods and/or evaluation toolsets that may be utilized to execute the respective software application evaluation task. In response, a second SAVER may post information on how to acquire, access, obtain and/or otherwise utilize one or more evaluation toolsets to execute the respective software application evaluation task.

The known evaluation toolset inventory data may be stored in a storage device (e.g., storage device 110) associated with the SAVER management system 102. The known evaluation toolset inventory data may comprise one or more evaluation toolset that are accessible by one or more SAVERs associated with an enterprise employing the SAVER management system 102. The known evaluation toolset inventory data may comprise data that describes how to implement one or more respective evaluation toolsets, what type of software application evaluation tasks may be executed in whole or in part by one or more respective evaluation toolsets, example software applications on which to utilize one or more respective evaluation toolsets, evaluation toolset access data (e.g., data related to SAVERs who have accessed and/or implemented the various evaluation toolsets, data related to computing devices used to access the known evaluation toolset inventory data), and/or self-reported data (e.g., comments, reviews, feedback, and/or the like reported by a SAVER) documenting the use, success, and/or failure of a particular evaluation toolset with respect to a particular software application evaluation task, and/or the like.

As shown by operation 504, the apparatus 200 may include means, such as processor 202, memory 204, SAVER assignment optimization model 212, and/or the like for determining, based on the evaluation toolset usage data, whether one or more evaluation toolsets of the set of available evaluation toolsets satisfies one or more evaluation task requirements of a set of evaluation task requirements of a given software application evaluation task. In this regard, the SAVER assignment optimization model 212 may take as input the various output generated from the SAVER analysis model 210. For example, as described herein, the SAVER analysis model 210 may be configured to parse and/or analyze evaluation toolset usage data associated with one or more SAVERs to detect a set of available evaluation toolsets that may be deployable for completing one or more software application evaluation tasks. In such examples, the SAVER analysis model 210 may be configured to provide output generated based on parsing and/or analyzing the evaluation toolset usage data associated with the one or more SAVERs (e.g., output related to a set of available evaluation toolsets) to the SAVER assignment optimization model 212. The SAVER assignment optimization model 212 may then be configured to determine which evaluation toolset(s) of the set of available evaluation toolsets may satisfy (e.g., upon implementation of the evaluation toolset(s)) one or more evaluation task requirements of the one or more respective software application evaluation task.

As shown by operation 506, the apparatus 200 may include means, such as processor 202, memory 204, SAVER management circuitry 208, SAVER assignment optimization model 212, and/or the like for determining a first evaluation toolset of the one or more available evaluation toolsets with which to execute the given software application evaluation task. For example, the SAVER assignment optimization model 212 may be configured to determine a first evaluation toolset with which to execute a particular software application evaluation task. Once the SAVER assignment optimization model 212 determines the first evaluation toolset, the SAVER management circuitry 208 may be configured to generate and/or provide an indication of the first evaluation toolset to one or more computing devices. For example, the SAVER management circuitry 208 may provide an indication of the first evaluation toolset to a computing device (e.g., an enterprise computing device 106A) associated with a SAVER that has been delegated to complete the given software application task for which the first evaluation toolset is suited to execute. In some examples, the indication of the evaluation toolset may comprise data related to the operation, implementation, and/or management of the evaluation toolset such that a SAVER may be enabled to successfully utilize the evaluation toolset to execute the given software application evaluation task at least in part by utilizing the evaluation toolset.

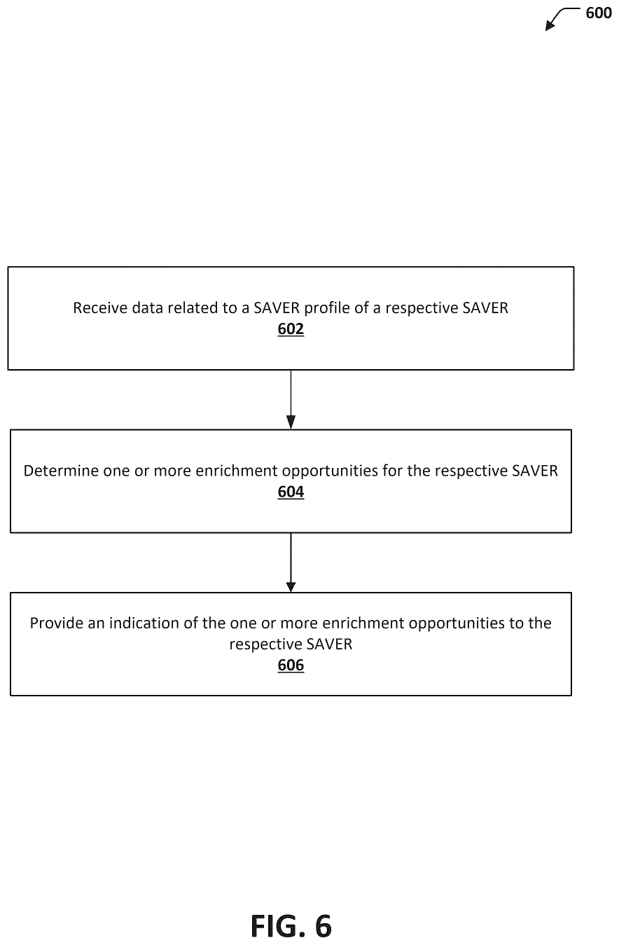

Turning next to FIG. 6, the flowchart 600 illustrates example operations for determining one or more training opportunities for a respective SAVER. As shown by operation 602, the apparatus 200 may include means, such as processor 202, memory 204, communications hardware 206, and/or the like for receiving data related to a SAVER profile of a respective SAVER. A SAVER profile may comprise data related to one or more of attribute data, strength data, weakness data, skillset data, ability data, productivity metric data, performance evaluation data, colleague feedback data, training record data, skill assessment result data, historical vulnerability detection results generated based on previously assigned software application evaluation tasks, identification data, workload data, availability data, or evaluation toolset data associated with the respective SAVER.

As shown by operation 604, the apparatus 200 may include means, such as processor 202, memory 204, communications hardware 206, SAVER analysis model 210, and/or the like for determining, based on the data associated with the SAVER profile, one or more enrichment opportunities for the respective SAVER. For example, the SAVER analysis model 210 may be configured to evaluate the SAVER profile associated with the respective SAVER to identify one or more enrichment opportunities that may improve one or more of the SAVER's performance, productivity metrics, weaknesses, skillsets, and/or the like. An enrichment opportunity may be a training course, specialization certification course, mandatory skills assessment, mentorship with a senior SAVER, human resources course, and/or the like that is designed to target and improve one or more SAVER attributes associated with the respective SAVER.

Additionally, in some examples, any results generated based on the completion of one or more enrichment opportunities by the respective SAVER may be utilized by the SAVER analysis model 210 to update and/or refine the SAVER profile associated with the SAVER such that one or more SAVER attributes may be updated. Additionally or alternatively, the SAVER profile associated with the respective SAVER may be updated to indicate that the SAVER has successfully or unsuccessfully completed one or more enrichment opportunities. In various examples, the SAVER analysis model 210 may be configured to evaluate SAVER profiles associated with one or more respective SAVERs associated with an enterprise on a routine basis. For example, the SAVER analysis model 210 may be configured to evaluate the SAVER profiles on a predetermined schedule such as once per month, once per quarter, once annually, and/or the like.

As shown by operation 606, the apparatus 200 may include means, such as processor 202, memory 204, communications hardware 206, and/or the like for providing an indication (e.g., a notification, digital correspondence, alert) of the one or more enrichment opportunities to the respective SAVER. For example, the communications hardware 206 may be configured to provide the indication of the one or more enrichment opportunities to a computing device (e.g., an enterprise computing device 106A, a user device 108A) associated with the respective SAVER. The indication may describe the one or more enrichment opportunities, one or more reasons why the one or more enrichment opportunities were suggested for the respective SAVER, and/or a timeframe for completing the one or more enrichment opportunities (e.g., in a case in which the enrichment opportunities are mandatory).

Additionally or alternatively, in various embodiments, the indication of the one or more enrichment opportunities may be interactive (e.g., may comprise one or more interactive user interface elements such as a hyperlink and/or button) such that the respective SAVER can provide acknowledgement of receipt of the indication of the one or more enrichment opportunities. For example, an interaction with a hyperlink and/or button associated with the work order may cause the generation and/or transmission of an acknowledgement that the first SAVER has received the indication. Furthermore, in some examples, the indication may comprise one or more interactive user interface elements configured to enable the SAVER to access the one or more enrichment opportunities. For example, a hyperlink or interactive button associated with the indication may be configured to provide the SAVER access to a web-based training course, certification course website, mandatory training video, and/or one or more various enrichment resources designed to improve one or more of the SAVER's performance, productivity metrics, weaknesses, skillsets, and/or the like.

FIGS. 3-6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods, systems, apparatuses, and computer program products that enable SAVER optimization. Example embodiments thus provide tools that overcome the problems faced by conventional methods for evaluating and/or testing software applications which, in some scenarios, require additional attention and effort on the part of a user to determine whether a particular software penetration tester, software security professional, software developer, white hat hacker, automated software application testing system, and/or the like is appropriately qualified to execute various software application evaluation tasks. Furthermore, embodiments provide the added benefit of automating the identification of various software application evaluation tasks that need to be completed with respect to particular software applications. By avoiding the use of conventional software application evaluation and/or testing methods, example embodiments thus save time and resources, while also mitigating the possibility of the loss of sensitive data as a result of poor software application evaluation, testing, and/or software security professional assignment.

Moreover, embodiments described herein employ various ML-based techniques for optimizing the selection of one or more SAVERs in order to maximize their abilities, efficiency, and proficiency while minimizing not only the weaknesses of the SAVERs, but also the time it takes to identify, diagnose, and/or mitigate one more vulnerabilities and/or security risks associated with a particular software application. In this regard, embodiments described herein provide AI-based methods for analyzing various performance attributes associated with respective SAVERs in order to generate a SAVER profile to be used in the optimization of said respective SAVERs. Furthermore, embodiments described herein provide the practical application of identifying and providing tailored enrichment opportunities for specific SAVERs that are designed to improve any weakness, performance deficits, and/or inefficiencies in the abilities of the SAVERs. Thus, embodiments described herein are configured to increase the aptitude of one or more SAVERs while simultaneously providing means for increasing the security of various software applications and any sensitive data related thereto.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for providing software application vulnerability evaluation resource (SAVER) optimization, the method comprising:
receiving, by communications hardware, a software application;
determining, by SAVER management circuitry, a first software application evaluation task for execution with respect to the software application, wherein the first software application evaluation task is associated with a first set of evaluation task requirements;
determining, by a SAVER assignment optimization model and based on the first set of evaluation task requirements, a first SAVER to execute the first software application evaluation task; and
providing, by the communications hardware, an indication of the first SAVER to a computing device.

2. The method of claim 1, further comprising:
determining, by the SAVER assignment optimization model, a first set of evaluation task constraints associated with the first software application evaluation task.

3. The method of claim 2, further comprising:
generating, by a SAVER analysis model, a SAVER profile associated with the first SAVER, wherein the SAVER profile comprises one or more of attribute data, strength data, weakness data, skillset data, ability data, productivity metric data, performance evaluation data, colleague feedback data, training record data, skill assessment result data, historical vulnerability detection results generated based on previously assigned software application evaluation tasks, identification data, workload data, availability data, or evaluation toolset data associated with the first SAVER.

4. The method of claim 3, further comprising:
determining, by the SAVER assignment optimization model, the first SAVER to execute the first software application evaluation task based on the SAVER profile associated with the first SAVER and the first set of evaluation task constraints associated with the first software application evaluation task.

5. The method of claim 1, further comprising:
receiving, by the communications hardware, first vulnerability detection results generated in response to execution of the first software application evaluation task;
storing, by the SAVER management circuitry, the first vulnerability detection results in a storage device;
updating, by a SAVER analysis model, a SAVER profile associated with the first SAVER based on the first vulnerability detection results; and
updating, by the SAVER management circuitry, the SAVER assignment optimization model based on the first vulnerability detection results.

6. The method of claim 5, further comprising:
determining, by the SAVER management circuitry and based on the first vulnerability detection results, a second software application evaluation task associated with the software application; and
determining, by the SAVER assignment optimization model, a second SAVER to execute the second software application evaluation task.

7. The method of claim 1, further comprising:
determining, by the SAVER assignment optimization model and based on the first set of evaluation task requirements, a second SAVER to execute the first software application evaluation task in conjunction with the first SAVER.

8. The method of claim 1, further comprising:
determining, by the SAVER assignment optimization model, a first evaluation toolset with which to execute the first software application evaluation task.

9. The method of claim 8, wherein determining the first evaluation toolset further comprises:
parsing, by a SAVER analysis model, evaluation toolset usage data associated with a set of SAVERs to detect a set of available evaluation toolsets; and
determining, by the SAVER assignment optimization model and based on the evaluation toolset usage data, whether one or more evaluation toolsets of the set of available evaluation toolsets satisfies one or more evaluation task requirements of the first set of evaluation task requirements of the first software application evaluation task.

10. An apparatus for providing software application vulnerability evaluation resource (SAVER) optimization, wherein the apparatus comprises:
communications hardware configured to receive a software application;
SAVER management circuitry configured to determine a first software application evaluation task for execution with respect to the software application, wherein the first software application evaluation task is associated with a first set of evaluation task requirements; and
a SAVER assignment optimization model configured to determine, based on the first set of evaluation task requirements, a first SAVER to execute the first software application evaluation task, wherein the communications hardware is configured to provide an indication of the first SAVER to a computing device.

11. The apparatus of claim 10, wherein the SAVER assignment optimization model is configured to determine a first set of evaluation task constraints associated with the first software application evaluation task.

12. The apparatus of claim 11, wherein the apparatus further comprises:
a SAVER analysis model configured to generate a SAVER profile associated with the first SAVER, wherein the SAVER profile comprises one or more of attribute data, strength data, weakness data, skillset data, ability data, productivity metric data, performance evaluation data, colleague feedback data, training record data, skill assessment result data, historical vulnerability detection results generated based on previously assigned software application evaluation tasks, identification data, workload data, availability data, or evaluation toolset data associated with the first SAVER.

13. The apparatus of claim 12, wherein the SAVER assignment optimization model is configured to determine the first SAVER to execute the first software application evaluation task based on the SAVER profile associated with the first SAVER and the first set of evaluation task constraints associated with the first software application evaluation task.

14. The apparatus of claim 10, wherein:
the communications hardware is configured to receive first vulnerability detection results generated in response to execution of the first software application evaluation task, and
the SAVER management circuitry is configured to store the first vulnerability detection results in a storage device;
wherein the apparatus further comprises a SAVER analysis model configured to update a SAVER profile associated with the first SAVER based on the first vulnerability detection results; and the SAVER management circuitry is configured to update the SAVER assignment optimization model based on the first vulnerability detection results.

15. The apparatus of claim 14, wherein the SAVER management circuitry is configured to determine, based on the first vulnerability detection results, a second software application evaluation task associated with the software application, and
wherein the SAVER assignment optimization model is configured to determine a second SAVER to execute the second software application evaluation task.

16. The apparatus of claim 10, wherein the SAVER assignment optimization model is configured to determine, based on the first set of evaluation task requirements, a second SAVER to execute the first software application evaluation task in conjunction with the first SAVER.

17. The apparatus of claim 10, wherein the SAVER assignment optimization model is configured to determine a first evaluation toolset with which to execute the first software application evaluation task.

18. The apparatus of claim 17, wherein the apparatus further comprises:
a SAVER analysis model configured to parse evaluation toolset usage data associated with a set of SAVERs to detect a set of available evaluation toolsets,
wherein the SAVER assignment optimization model is configured to determine, based on the evaluation toolset usage data, whether one or more evaluation toolsets of the set of available evaluation toolsets satisfies one or more evaluation task requirements of the first set of evaluation task requirements of the first software application evaluation task.

19. A computer program product for providing software application vulnerability evaluation resource (SAVER) optimization, the computer program product comprising at least one non-transitory computer-readable storage medium storing software instructions that, when executed, cause an apparatus to:
receive, by communications hardware, a software application;
determine, by SAVER management circuitry, a first software application evaluation task for execution with respect to the software application, wherein the first software application evaluation task is associated with a first set of evaluation task requirements;
determine, by a SAVER assignment optimization model and based on the first set of evaluation task requirements, a first SAVER to execute the first software application evaluation task; and
provide, by the communications hardware, an indication of the first SAVER to a computing device.

20. The computer program product of claim 19, wherein the software instructions cause the apparatus to:
determine, by the SAVER assignment optimization model, a first set of evaluation task constraints associated with the first software application evaluation task;
generate, by a SAVER analysis model, a SAVER profile associated with the first SAVER, wherein the SAVER profile comprises one or more of attribute data, strength data, weakness data, skillset data, ability data, productivity metric data, performance evaluation data, colleague feedback data, training record data, skill assessment result data, historical vulnerability detection results generated based on previously assigned software application evaluation tasks, identification data, workload data, availability data, or evaluation toolset data associated with the first SAVER; and
determine, by the SAVER assignment optimization model, the first SAVER to execute the first software application evaluation task based on the SAVER profile associated with the first SAVER and the first set of evaluation task constraints associated with the first software application evaluation task.
